(19) United States
(12) Patent Application Publication
(10) Pub. No.: US 2017/0172073 A1
(43) Pub. Date: Jun. 22, 2017

(54) SUPPORTING CLAMP APPARATUS AND PROCESS

(71) Applicant: Barend J. Van Den Heever, Winter Garden, FL (US)

(72) Inventor: Barend J. Van Den Heever, Winter Garden, FL (US)

(21) Appl. No.: 14/973,814

(22) Filed: Dec. 18, 2015

(51) Int. Cl. A01G 9/12; A01G 17/00; A01G 1/00; A01G 17/04

(52) U.S. Cl. CPC A01G 9/128; A01G 17/04; A01G 17/005; A01G 1/001

(57) ABSTRACT

This invention relates to a clamp for holding a pair of spaced objects together and especially to a clamp for supporting a tree trunk or plant to an upright stake or post. The clamp body has a pair of hinged arms having two end portions with each end portion having a clamping jaw for attaching over a pair of spaced objects to be supported to each other, such as a tree trunk to a supporting stake, when said hinged arms are closed. The hinged arms having a snap lock connector for attaching the arms together when said hinged arms are closed so that an object supporting clamp can be attached over a pair of spaced objects for supporting one object to the other object.

### FIELD OF THE INVENTION

This invention relates to a clamp for holding a pair of spaced objects together and especially to a clamp for supporting a tree trunk or plant to an upright stake or post.

### BACKGROUND OF THE INVENTION

Protecting a new or young tree by supporting the tree to a stake or the like enables it to grow a strong root system needed to secure itself in the ground. Newly planted trees can be susceptible to falling over in heavy winds so that it has been a common practice to add additional support by staking the tree.

During the preliminary growing process of trees especially in a nursery setting, the young tree must be supported against wind damage and otherwise maintained in an upright position. One currently available method of supporting trees directly to supporting structures consists of tying a length of material such as rope, wire, vinyl tape, twine, twist ties or the like around the trunk of the tree or around a supportive structure such as a vertical stake or horizontal beam. A disadvantage of this type of support is that the tree trunk may become chafed against the supportive structure or that girdling may result when wire or coated wire ties are used or the length of material can rot or poorly tied knots can loosen or come completely loose.

Prior art devices for staking a tree or plant or fence post or the like may be seen in the U.S. Patent to Veneziano et al., U.S. Pat. No. 5,568,700 for a stand off device for yieldingly supporting a tree to a tree support stake which wraps a strap around a tree and attaches the strap to a vertical stake. In the Dickinson U.S. Pat. No. 4,738,050 a plant and tree support clamp laterally restrains the tree in conjunction with a supportive structure or stake. The Zayer U.S. Patent Application Publication No. US 2006/0150483 is for a tree support assembly which supports a tree trunk to a spaced tree support stake with a bracket having a support stake end and a free end extending toward the tree trunk. Other ways of supporting a tree or post can be seen in the Boucher U.S. Design Pat. No. D463,721 for a tree support and in the Eby U.S. Pat. No. 4,381,621 for a tree stand and in the Ness et al. U.S. Pat. No. 4,649,666 for a self-stabilizing tree support assemblies and in the Reisner U.S. Pat. No. 4,307,540 for a display holder for a plurality of Christmas trees. Supports are also shown in U.S. Pat. No. 3,010,256 to R. E. Ise for a tree support which attaches a tree trunk to a fence post and in the U.S. Patent to E. J. Stropkay, U.S. Pat. No. 3,526,056 for an adjustable loop tree tie fastener for attaching a tree trunk to a stake. Other ways of supporting a tree or post can be seen in the P. A. Peterson U.S. Pat. No. 1,725,475 for a fence post clamp and in the Knapp U.S. Pat. No. 6,883,785 for a bracket for T-post fence braces and gates and in the Tatarnic U.S. Patent Application Publication No. US 2002/0095813 for a fence post positioning apparatus.

The present invention is for a clamp for holding a pair of spaced objects, such as a new tree in a nursery, in an upright position. The clamp can clamp a tree trunk, or the like, to a supporting stake or post in an upright position by simply closing the hinged clamp arms over the tree trunk and stake to lock them together.

### SUMMARY OF THE INVENTION

This invention relates to a clamp for holding a pair of spaced objects together and especially to a clamp for supporting a tree trunk or plant to an upright stake or post. The clamp body has a pair of hinged arms having two end portions with each end portion having a clamping jaw for attaching over a pair of spaced objects to be supported to each other, such as a tree trunk to a supporting stake, when said hinged arms are closed. The hinged arms have a snap lock connector for attaching the arms together when the hinged arms are closed so that an object supporting clamp can be attached over a pair of spaced objects for supporting one object with the other. The clamp hinged arms has a pair of snap locks connectors for holding the hinged arms together when closed. Each hinged arm may also have a spring which may be molded therein to allow the arm to flex and adjust the grip on each object as the arms are closed over a pair of objects. The clamp also has a shim removably attached thereto which may be removed and reattached in one of the jaws for adjusting the clamping of the jaw to an object. The entire clamp may be molded in one polymer piece with a living hinge and a polymer spring in each arm.

### BRIEF DESCRIPTION OF THE DRAWINGS

The accompanying drawings, which are included to provide further understanding of the invention, are incorporated in and constitute a part of the specification and illustrate an embodiment of the invention and together with the description serve to explain the principles of the invention.

In the drawings:

FIG. 1 is a sectional view of a clamp in accordance with the present invention holding a tree trunk to a stake;

FIG. 2 is a perspective view of the clamp of FIG. 1 attached to a tree trunk and to a stake;

FIG. 3 is a perspective view of the clamp in accordance with the present invention;

FIG. 4A is an exploded perspective view of one end of the present clamp having the shim removed therefrom;

FIG. 4B is a top sectional view of one end of the present clamp showing the shim placed therein;

FIG. 5 is a perspective view of the other end portion of the clamp of FIG. 4B illustrating the operation of a snap lock;

FIG. 6A is a sectional view of the clamp of the present invention in a open position;

FIG. 6B is a sectional view of the clamp of the present invention in a closed position; and

FIG. 7 is a perspective view of one end of an alternate embodiment of the clamp of the present invention.

### DETAILED DESCRIPTION OF AN EXEMPLARY EMBODIMENT

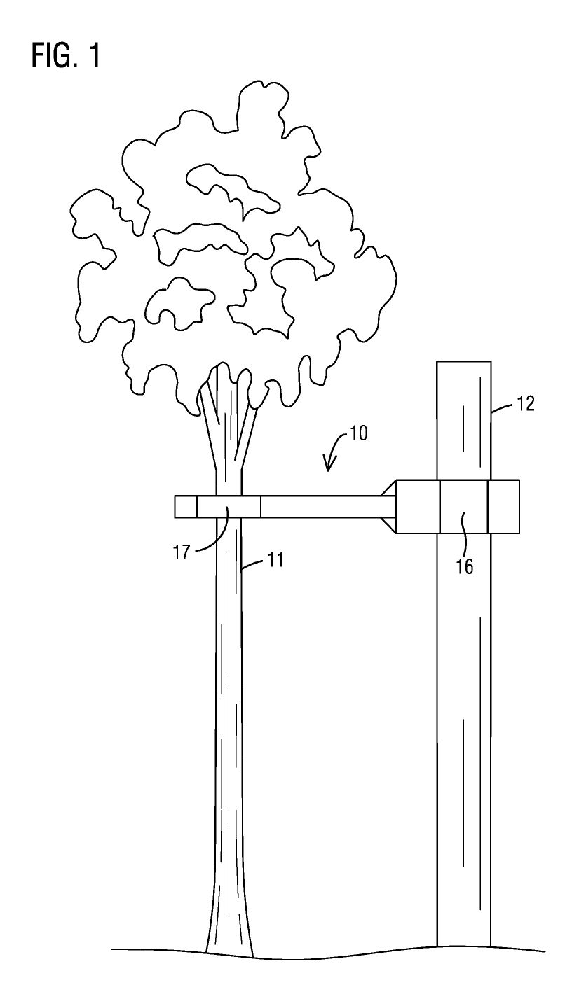

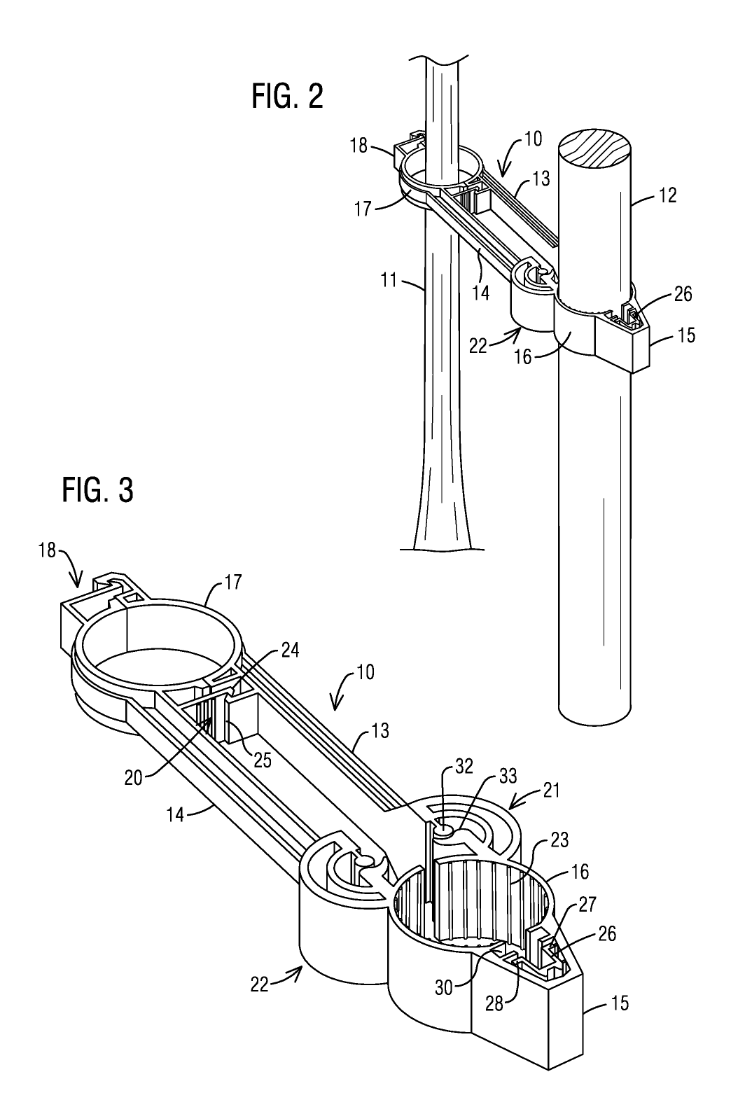

This invention relates to a clamp 10 for holding a pair of spaced objects together and especially to a clamp 10 for supporting a tree trunk or plant 11 to an upright stake or post 12 as seen in FIGS. 1 and 2.

Referring to the drawings, FIGS. 1 through 6A & B, and especially to FIG. 1 through 3, a clamp 10 has a pair of arms 13 and 14 hinged with a living hinge 15 which arms have a pair of spaced jaws 16 and 17 formed in the arms 13 and 14. The clamp 10 hinged arms have a pair of snap locks 18 and 20 formed thereinto which lock the arms 13 and 14 together as shown in FIGS. 2 and 3. The clamp 10 also has a pair of springs 21 and 22 formed therein to allow expansion of the jaws 16 and 17 when clamping the jaws onto an object, such as a tree trunk 11 and a supporting stake 12, as seen in FIGS. 1 and 2. The entire clamp 10 can be made of one molded polymer piece but may also be made in parts as desired. The jaw 16 can be seen having a plurality of gripping ridges 23 formed therein.

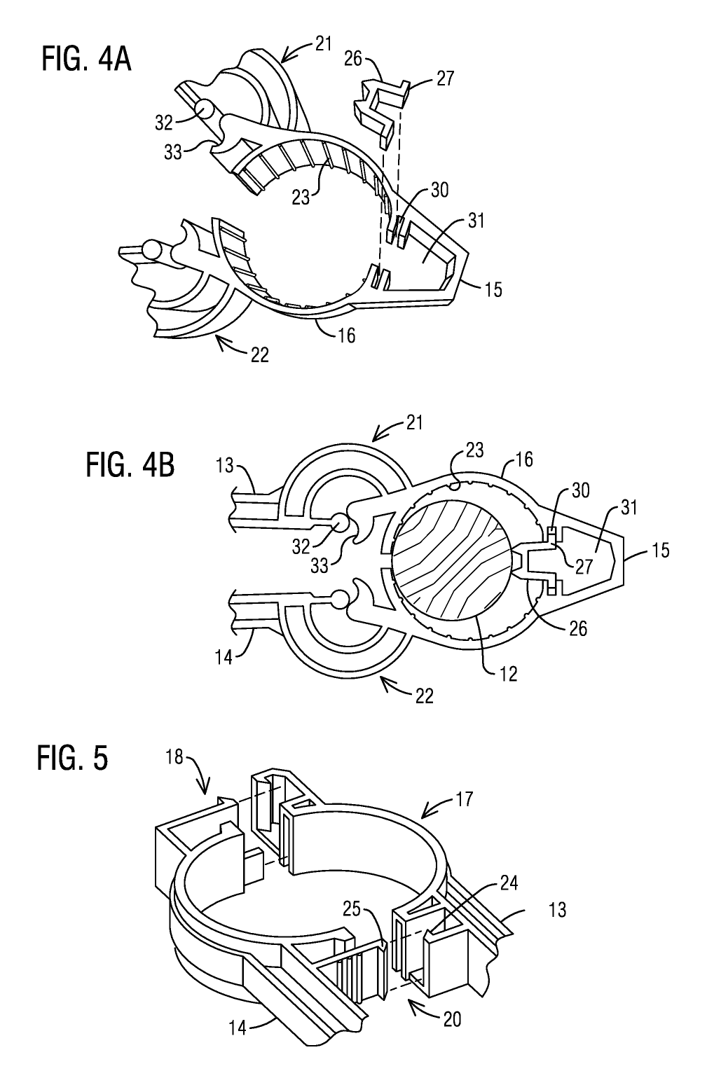

The snap locks 18 and 20 are formed having one piece on each arm extending inward with a hook 24 on the end of one extension from one arm and for locking with a hook 25 on the other arm. One or two snap locks can be used to lock the hinged arms 13 and 14 together as desired. The clamp 10 can also be seen as having a shim 26 having a pair of flanges 27 which shim is removably attached with a connecting tab 28. The hinged clamp 10 also has a pair of grooves 30 formed adjacent the jaw 16 which grooves 30 are spaced one from the other to form a track for sliding of the flanges 27 thereinto when the shim 26 is removed from its attached position in space 31 as shown in FIGS. 2 and 3 and reversed as shown in FIGS. 4A and 4B to adjust the fitting for different sized objects being clamped as seen in FIG. 4B. Arm 13 of the clamp 10 has a spring 22 therein while arm 14 has a spring 22 therein allowing the arms to flex when attaching the jaw 16 to an object 12.

As seen in FIGS. 4A and 4B the shim 26 has been removed from the space 31 and reversed and the flanges 27 inserted into the grooves 30 spacing an object as seen in FIG. 4B to allow for a better clamping on the object in jaw 16.

FIG. 5 illustrates the snap hinge 18 having an extending portion having a hook 24 on one end for engaging a hook 25 on the other arm's extension to lock the arms 13 and 14 together with the jaws 16 and 17 clamping onto a pair of spaced objects.

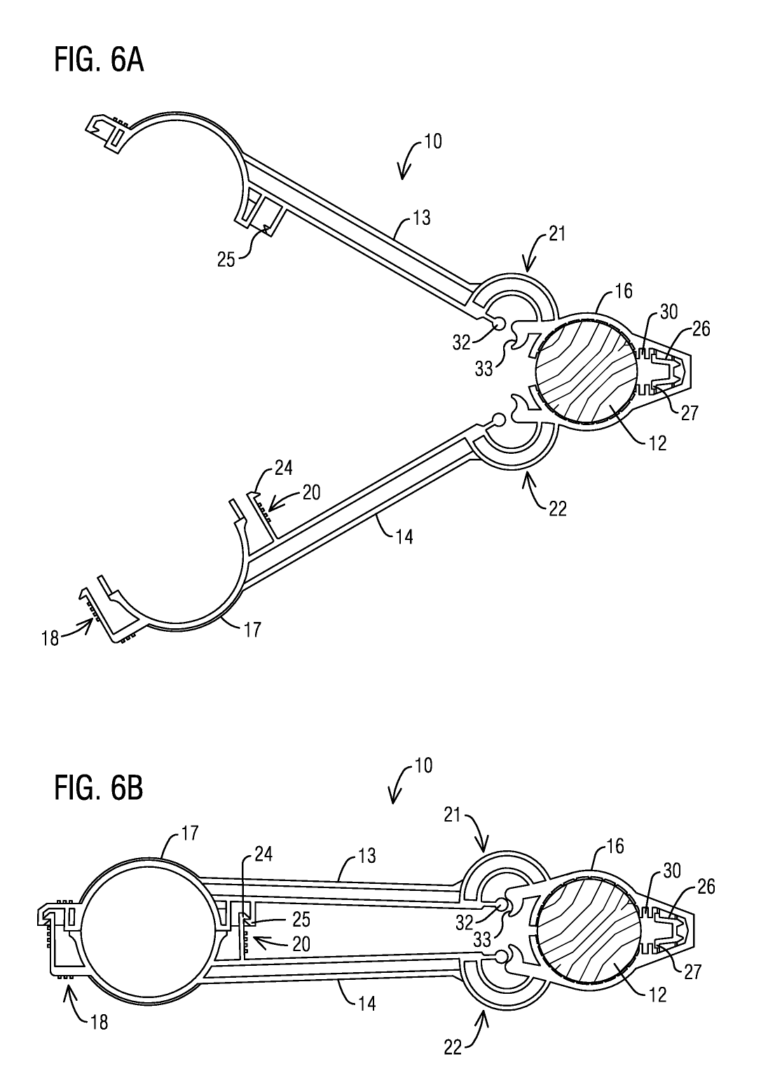

As seen in FIGS. 6A and 6B, the clamp 10 has the hinged arms 13 and 14 swung open in FIG. 6A and closed and locked together in FIG. 6B clamping a stake 11. In FIG. 6A the arm springs 21 and 22 are flexed to allow the stake 12 to be positioned therein. The arms 13 and 14 are then closed as in FIG. 6B with the springs swung back into place with the spring knobs 32 caromed against the surface 33.

A method of clamping a plant 11 to a supporting stake 12 in accordance with the present invention first selects a clamp 10 having a pair of hinged arms 13 and 14 having two end portions and having open (FIG. 6A) and closed (FIG. 6B) positions and each end portion of the clamp 10 having a clamping jaw 16 and 17 and the hinged arms 13 and 14 having one or more snap lock connectors 18 and 20 for locking the pair of hinged arms 13 and 14 together when the hinged arms are in a closed position. The clamp 10 hinged arms 13 and 14 open to allow one clamp jaw to be placed over plant 11 and the other hinged arm jaw to be placed around a stake 12. The clamp arms can then be closed (FIGS. 1 and 2) with the clamped jaw clamped onto both the plant and the stake to hold one to the other in a predetermined spaced relationship. The clamp arms 13 and 14 are locked together by the closing of the hinged arms together with one or more snap locks 18 and 20. This thereby clamps a plant 11 to a supporting stake 12 to support the plant in an upright or desired position.

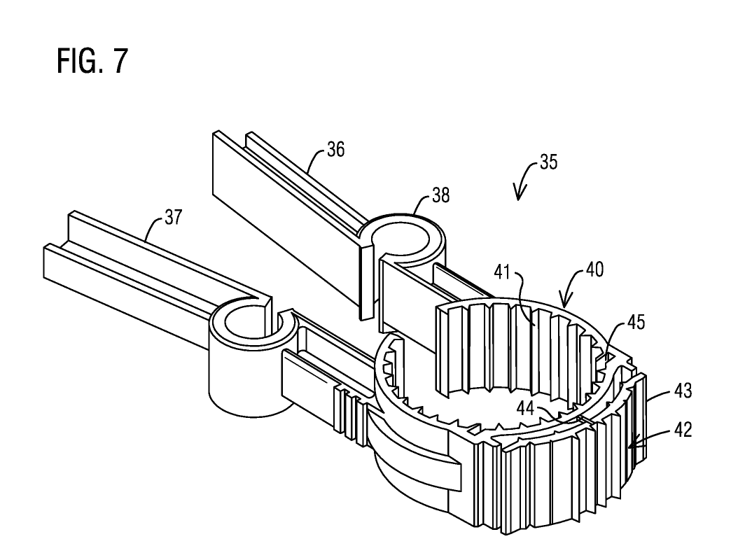

Referring to FIG. 7, an alternate embodiment of one end of the clamp of the present invention is illustrated. The clamp 35 has arms 36 and 37 each having a spring 38 formed therein. The jaw 40 has gripping ridges 41 similar to the embodiment seen in FIGS. 1 through 6. In this embodiment a shim 42 is placed on the outside of the jaw 16 and has end flanges 43 on each end thereof. The shim 42 is attached to the jaw 40 with small connecting tab 44. The shim 42 can be removed from the outside of the jaw and reversed and the flanges 43 slid into the grooves 45 on the inside of the jaw 40 to reduce the jaw's size for a better grip on a tree trunk or the like.

It should be clear at this time that a method and apparatus for clamping a plant to a supporting stake or the like has been provided. However the present invention is not to be considered limited to the forms shown which are to be considered illustrative rather than restrictive.

I claim:

1. A clamp for holding a pair of objects to each other comprising:
a clamp body having a pair of hinged arms having two end portions and having open and closed positions, each end portion of said clamp body having a clamping jaw for attaching over a pair of spaced objects to be held in a spaced relationship to each other when said hinged arms are in a closed position, and said hinged arms having a snap lock connector for attaching said pair of hinged arms together when said hinged arms are in a closed position;
whereby a pair of objects can be clamped in a spaced relationship to each other.

2. The clamp for holding a pair of objects to each other in accordance with claim 1 having two snap lock connectors for holding said pair of hinged arms together.

3. The clamp for holding a pair of objects to each other in accordance with claim 2 in which one said hinged arm has a spring therein.

4. The clamp for holding a pair of objects to each other in accordance with claim 2 in which each said hinged arm has a spring therein.

5. The clamp for holding a pair of objects to each other in accordance with claim 3 in which one of said clamped jaws has a generally arcuate jaw member in each clamp arm to form a generally circular jaw when said pair of hinged arms are in a closed position.

6. The clamp for holding a pair of objects to each other in accordance with claim 3 in which each of said clamp jaws have two generally annular jaw members in each clamp arm to form a pair of generally circular jaws when said pair of hinged arms are in a closed position.

7. The clamp for holding a pair of objects to each other in accordance with claim 6 in which said clamp body has a shim removably attached thereto for placement in one said jaw for adjusting said jaw for holding an object therein.

8. The clamp for holding a pair of objects to each other in accordance with claim 7 in which said shim has a pair of flanges extending therefrom.

9. The clamp for holding a pair of objects to each other in accordance with claim 8 in which each arm of said clamp body has a groove therein shaped to receive one of said pair of shim flanges therein for holding said shim within one said clamping jaw.

10. The clamp for holding a pair of objects to each other in accordance with claim 1 in which said hinged clamp pair of arms are hinged together with a living hinge.

11. The clamp for holding a pair of objects to each other in accordance with claim 1 in which one said clamping jaw has a plurality of gripping ridges therein.

12. The clamp for holding a pair of objects to each other in accordance with claim 1 in which said clamp body is an injection formed polymer body.

13. The clamp for holding a pair of objects to each other in accordance with claim 6 in which said clamp body has a shim removably attached to the outside of one said jaw for removably attaching inside said jaw for adjusting said jaw for holding an object therein.

14. The clamp for holding a pair of objects to each other in accordance with claim 13 in which said shim has a pair of flanges extending therefrom for insertion into a pair of grooves formed inside said jaw.

15. A method of clamping a plant to a supporting stake comprising the steps of:
selecting a clamp having a pair of hinged arms having two end portions and having open and closed positions, each end portion of said clamp having a clamping jaw and said hinged arms having a snap lock connector for attaching said pair of hinged arms together when said hinged arms are in a closed position;
opening the hinged arms of said clamp to said open position;
placing one said clamp jaw onto a stake and the other clamp jaw onto a plant;
closing said hinged arms together to close said one jaw onto said stake and the other hinged jaw onto said plant; and
locking said clamp arms together with said snap lock;
whereby a plant is clamped to a supporting stake.

16. A method of clamping a plant to a supporting stake in accordance with claim 15 in which said selected clamp has an attached shim.

17. A method of clamping a plant to a supporting stake in accordance with claim 16 including the step of removing said attached shim from said clamp, inverting and attaching said removed shim inside one said jaw.
